(19) United States
(12) Patent Application Publication
(10) Pub. No.: US 2017/0298521 A1
(43) Pub. Date: Oct. 19, 2017

(54) FILAMENT WITH EXTERIOR BARRIER AND METHOD OF PRODUCING SAME

(71) Applicant: Stratasys, Inc., Eden Prairie, MN (US)

(72) Inventors: Benjamin A. Demuth, River Falls, WI (US); Adam R. Pawloski, Lake Elmo, MN (US); Neil R. Granlund, Columbia Heights, MN (US)

(21) Appl. No.: 15/483,595

(22) Filed: Apr. 10, 2017

Related U.S. Application Data
(60) Provisional application No. 62/321,945, filed on Apr. 13, 2016.

(51) Int. Cl. C23C 30/00; B33Y 50/02; B05D 3/02; B33Y 70/00; B05D 3/06; B33Y 10/00; B29K 101/12

(52) U.S. Cl. CPC C23C 30/00; B05D 3/06; B33Y 50/02; B33Y 10/00; B05D 3/0254; B33Y 70/00; B29K 2101/12; B29K 2995/0067

(57) ABSTRACT

A material for an additive manufacturing system having a build environment includes a filament coated with a barrier wherein barrier comprises less than about 1 wt % of the filament wherein the barrier substantially prevents the transmission of moisture or gasses into the filament.

### CROSS REFERENCE TO RELATED APPLICATION(S)

This application claims the benefit of U.S. Provisional Patent Application Ser. No. 62/321,945 entitled FILAMENT WITH EXTERIOR BARRIER AND METHOD OF PRODUCING SAME that was filed on Apr. 13, 2016, the contents of which are incorporated by reference in its entirety.

### BACKGROUND

The present disclosure relates to additive manufacturing systems for printing three-dimensional (3D) parts and support structures. In particular, the present disclosure relates to materials for use in additive manufacturing systems, consumable assemblies retaining the materials, and methods of manufacturing and using the materials and assemblies in additive manufacturing systems to print articles.

Additive manufacturing, or 3D printing, is generally a process in which a three-dimensional (3D) object is built utilizing a digital model or representation of the object. A typical additive manufacturing process consists of slicing a three-dimensional computer model into thin cross sections defining a series of layers, translating the results into vector or bitmapped position data, and feeding the data to control a printer which manufactures a three-dimensional structure in a layerwise manner using one or more additive manufacturing techniques. Additive manufacturing entails many different approaches to the method of fabrication, including fused deposition modeling, ink jetting, selective laser sintering, powder/binder jetting, electron-beam melting, electrophotographic imaging, and stereolithographic processes.

In a fused deposition modeling additive manufacturing system, a printed part may be printed from a digital representation of the printed part in a layer-by-layer manner by extruding a flowable part material along toolpaths defined according to vector position data. The part material is extruded through an extrusion tip carried by a print head of the system, and is deposited as a sequence of roads on a substrate in a build plane. The extruded part material fuses to previously deposited part material, and solidifies upon a drop in temperature. The position of the print head relative to the substrate is then incremented along a print axis (perpendicular to the build plane), and the process is repeated to form a printed part resembling the digital representation.

In fabricating printed parts by depositing layers of a part material, supporting layers or structures are typically built underneath overhanging portions or in cavities of printed parts under construction, which are not supported by the part material itself. A support structure may be built utilizing the same deposition techniques by which the part material is deposited. A host computer generates additional geometry acting as a support structure for the overhanging or free-space segments of the printed part being formed. Support material is then deposited pursuant to the generated geometry during the printing process. The support material can adhere to the part material during fabrication, and is removable from the completed printed part when the printing process is complete. Break-away and soluble support materials are known, wherein methods of removing the support material include either breaking the printed support structure off of the part material, or immersing the printed part and support structure in an aqueous bath to dissolve away the support material.

A polymeric consumable feedstock material, such as a spooled filament, used as a printing material in extrusion-based additive technologies can absorb moisture resulting in a degraded performance and print quality, unless steps are taken to dry the consumable material and/or maintain dryness of the material before it is printed. When the polymer material is heated to its extrusion temperature, any moisture contained in the material may boil and vaporize, creating voids and defects in the extruded roads. High-temperature polymers and composite materials are particularly susceptible to this problem. Hydrophilic materials used to print soluble supports are likewise susceptible to degradation caused by moisture penetration in the feedstock material. Commercial Stratasys FDM® printers of the prior art solve this problem using air-tight filament containers and pathways, desiccant, and/or compressed-air drying systems to keep filament feedstock dry as it is fed through the machine to the extruder.

### SUMMARY

In a first aspect, the present disclosure relates to filament feed stock that includes an external barrier of a different material than that of the filament material. The barrier substantially covers an entire outer surface of the filament. The barrier is less than or equal to about 1 wt % of the total weight of the filament. A barrier with a sufficiently low wt % prevents moisture and/or gases from transmitting into the feedstock while not affecting the properties of the feedstock when extruded to form a 3D part or a support structure for the 3D part. The barrier can be applied to the filament feedstock through a coating and drying process, a thermal curing process, a light curing process, a vapor deposition process, and/or a coextrusion process.

In a further aspect, the present disclosure includes a method for producing a consumable filament with an external barrier for use in an additive manufacturing system. The method includes providing a filament of a suitable cross-section and material to be utilized as a part material or a support material in the additive manufacturing system. The filament is then coated with a barrier of a material different from than filament material where the barrier substantially covers an entire outer surface of the filament and provides a barrier to moisture and/or gases from transmitting into the feedstock. The barrier is less than or equal to about 1 wt % of the total weight of the filament. The barrier may be applied utilizing a coating and drying technique, a thermal curing technique, a light curing technique, a vapor deposition process, and/or a coextrusion process. Non-limiting examples of suitable materials for use as the external barrier includes low molecular weight polyethylene dispersions, fluoroacrylates, dicyandiamine cured epoxies, silane and/or polydimethylsiloxane dispersions, acrylic esters with a phosphine oxide photoinitiator, microparticle coating with a metal or a metal oxide and polymers or copolymers capable of significantly reducing moisture and/or gas transmission.

In yet a further aspect, the present disclosure includes a method for printing a three-dimensional part with an additive manufacturing system in a layer by layer manner where each layer includes a plurality of roads. The method includes providing a thermoplastic feedstock material coated with an external barrier, of a material different from that of the thermoplastic feedstock, where the barrier is less than or equal to about 1 wt % of the total weight of the filament. The feedstock material is fed into an extruder within the additive manufacturing system, heated to a molten state and extruded along tool paths to print a 3D part, wherein the material exhibits flow within the extruder and an elongation force as it extrudes. The elongation force breaks up the coating to disrupt the barrier such that the thermoplastic material is exposed such that the barrier does not adversely affect the bonding of the extruded thermoplastic material in adjacent roads and/or layers. With some filaments and coated with the barrier, the barrier is no longer detectable after being extruded.

### Definitions

Unless otherwise specified, the following terms as used herein have the meanings provided below:

The terms “preferred”, “preferably”, “example” and “exemplary” refer to embodiments that may afford certain benefits, under certain circumstances. However, other embodiments may also be preferred or exemplary, under the same or other circumstances. Furthermore, the recitation of one or more preferred or exemplary embodiments does not imply that other embodiments are not useful, and is not intended to exclude other embodiments from the inventive scope of the present disclosure.

Reference to “a” chemical compound refers one or more molecules of the chemical compound, rather than being limited to a single molecule of the chemical compound. Furthermore, the one or more molecules may or may not be identical, so long as they fall under the category of the chemical compound. Thus, for example, “a” polyetherimide is interpreted to include one or more polymer molecules of the polyetherimide, where the polymer molecules may or may not be identical (e.g., different molecular weights and/or isomers).

The terms “at least one” and “one or more of” an element are used interchangeably, and have the same meaning that includes a single element and a plurality of the elements, and may also be represented by the suffix “(s)” at the end of the element. For example, “at least one polyetherimide”, “one or more polyetherimides”, and “polyetherimide(s)” may be used interchangeably and have the same meaning.

The terms “about” and “substantially” are used herein with respect to measurable values and ranges due to expected variations known to those skilled in the art (e.g., limitations and variability in measurements).

The term “providing”, such as for “providing a support material”, when recited in the claims, is not intended to require any particular delivery or receipt of the provided part. Rather, the term “providing” is merely used to recite parts that will be referred to in subsequent elements of the claim(s), for purposes of clarity and ease of readability.

Unless otherwise specified, temperatures referred to herein are based on atmospheric pressure (i.e. one atmosphere).

“Soluble” as referred to herein can be used interchangeably with “disintegrable” and “dissolvable” and relates to materials that disintegrate in a solution or dispersion. Upon disintegration, the support material can break apart into smaller pieces and/or particles of polymer in the solution or dispersion. Some or all of the support material may also dissolve into the solution or dispersion upon disintegration.

“Water soluble” as used herein relates to materials that dissolve in tap water that is about neutral pH. It is understood that the pH of tap water can vary depending on the municipality and as such the pH can vary between about 5 and about 9. Although these pHs are slightly basic or slightly acidic, the defining feature of the water soluble materials is that they do not require an acidic or basic solution to disintegrate and can disintegrate in water at about neutral pH, e.g. tap water.

### BRIEF DESCRIPTION OF THE DRAWINGS

FIG. 1 is a front view of an extrusion-based additive manufacturing system configured to print printed parts and support structures, where the support structures are printed from a support material of the present disclosure.

FIG. 2 is a front view of a print head of the extrusion-based additive manufacturing system.

FIG. 3 is an expanded sectional view of a drive mechanism, a liquefier assembly, and a nozzle of the print head for use in the extrusion-based additive manufacturing system.

FIG. 4A is a perspective view of a segment of a cylindrical filament of the support material.

FIG. 4B is a perspective view of a segment of a ribbon filament of the support material.

FIG. 4C is a perspective view of a segment of a hollow filament of the support material.

FIG. 4D is a perspective view of a segment of a cylindrical core-shell filament of the support material.

FIG. 4E is a perspective view of a segment of a ribbon core-shell filament of the support material.

FIG. 5A is a perspective view of a first embodied consumable assembly for retaining a supply of the support material in filament form.

FIG. 5B is a perspective view of the first embodied consumable assembly in an open state, illustrating an interior of the first embodied consumable assembly.

FIG. 6A is a perspective view of a second embodied consumable assembly for retaining a supply of the support material in filament form.

FIG. 6B is an expanded perspective view of the second embodied consumable assembly, illustrating an integrated print head and guide tube.

FIG. 6C is a perspective view of a container portion of the second embodied consumable assembly.

FIG. 7 is a perspective view of a material of the present disclosure after being extruded from a liquefier of an additive manufacturing system.

### DETAILED DESCRIPTION

The present disclosure is directed to a consumable material for use in an extrusion-based additive manufacturing system, a method of producing the consumable material and a method of printing a three-dimensional part utilizing the consumable material. The consumable material is a feedstock, such as a filament, that has a barrier that substantially or entirely covers an exterior surface. The barrier prevents the transmission of moisture or gases from the environment into the feedstock.

A typical material of the filament material is a thermoplastic, polymer or copolymer material. When used in additive manufacturing systems, the thermoplastic, polymer or copolymer material can be part material or support material. The material of the filament can also include sensitive chemistries having active ingredients that are susceptible to degradation when exposed to moisture or certain gasses, such as oxygen. The material of the filament can also include foodstuffs that can also be sensitive to moisture and gas transmission.

Many polymer materials that are used in an additive manufacturing system are susceptible to moisture absorption. If exposed to ambient air, these materials will absorb moisture from the air, and their performance will be degraded. When feedstock material is heated to extrusion temperatures in an extruder or liquefier, any moisture contained in the feedstock may boil and create voids and other detrimental effects in the material as it is extruded. When the material absorbs a sufficient amount of moisture, melting, extruding and depositing material can be difficult due to foaming caused by the rapid change in volume of the moisture as it transforms from a liquid to a vapor. Foaming has been found to be a problem in extruding support materials in an additive manufacturing system, because a typical support material is a water soluble material that readily absorbs moisture from the environment. Further, the extrusion of material with absorbed moisture can adversely affect physical properties of the material. High temperature polymers and composite materials are particularly susceptible to this problem. In some instances, the amount of absorbed moisture can result in the material being discarded.

In some additive manufacturing of three-dimensional parts, the transmission or absorption of gases into the feedstock may detrimentally affect the quality of the end product. For instance, when a three-dimensional part is printed as an implant for positioning into a living being, it can be advantageous to include active ingredients that can aid in acceptance by the body or to aid in preventing infection. By way of non-limiting example, the thermoplastic feedstock may include suitable amounts of growth factor to aid in acceptance by the body or antibiotics to aid in the prevention of infection. However, these active ingredients can be susceptible to oxidation through transmission or absorption of oxygen from the environment. While the present application addresses the issues surrounding oxidation of compounds in an implant, the present disclosure can be utilized to prevent the transmission of gases into the filament.

In some additive manufacturing, foodstuffs can be printed in a layer by layer manner. By way of non-limiting example, chocolate based confections can be printed as disclosed in Zimmerman et al. U.S. Pat. No. 9,215,882. When printing foodstuff, moisture absorption into the filament can make the printing of the foodstuff difficult and the transmission of gasses from the ambient environment into the foodstuff may adversely affect the taste of the foodstuff

The present disclosure prevents the absorption of water or gasses from the ambient environment by coating the material with a barrier, where the barrier can be up to about 1 wt % of the total weight of the filament. The wt % of the barrier is sufficiently low relative to the material such that the barrier material does not adversely affect the performance of the extruded material.

The wt % of the barrier is at least 0.001 wt % and the present disclosure encompasses all ranges between 0.001 wt % and 1.0 wt % of the total weight of the filament. In some embodiments, the wt % of the barrier is between about 0.001 wt % and about 0.05 wt % of the total weight of the filament. In yet other embodiment, the wt % of the barrier is between about 0.001 wt % and about 0.003 wt % of the total weight of the filament.

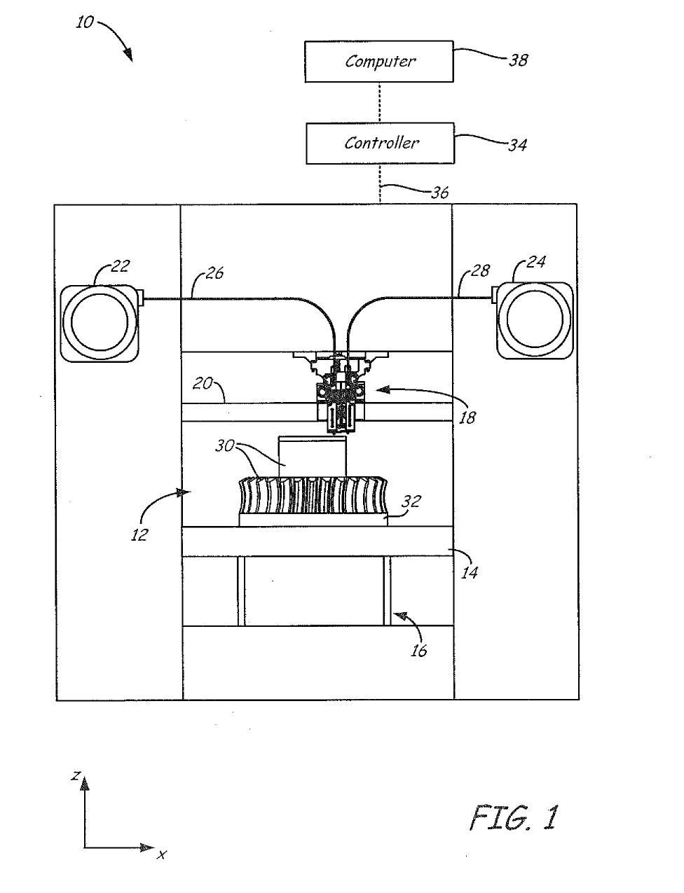

As shown in FIG. 1, system 10 is an example of an extrusion-based additive manufacturing system for printing or otherwise building 3D parts and support structures using a layer-based, additive manufacturing technique, where the support structures may be printed from the support material of the present disclosure. Suitable extrusion-based additive manufacturing systems for system 10 include fused deposition modeling systems developed by Stratasys, Inc., Eden Prairie, Minn. under the trademark “FDM”.

In the illustrated embodiment, system 10 includes chamber 12, platen 14, platen gantry 16, print head 18, head gantry 20, and consumable assemblies 22 and 24. Chamber 12 is an enclosed environment that contains platen 14 for printing printed parts and support structures. Chamber 12 may be heated (e.g., with circulating heated air) to reduce the rate at which the part and support materials solidify after being extruded and deposited. In alternative embodiments, chamber 12 may be omitted and/or replaced with different types of build environments. For example, parts may be built in a build environment that is open to ambient conditions or may be enclosed with alternative structures (e.g., flexible curtains).

Platen 14 is a platform on which printed parts and support structures are printed in a layer-by-layer manner. In some embodiments, platen 14 may also include a flexible polymeric film or liner on which the printed parts and support structures are printed. In the shown example, print head 18 is a dual-tip extrusion head configured to receive consumable filaments from consumable assemblies 22 and 24 (e.g., via guide tubes 26 and 28) for printing printed part 30 and support structure 32 on platen 14. Consumable assembly 22 may contain a supply of a model material, such as a high-performance model material, for printing printed part 30 from the model material. Consumable assembly 24 may contain a supply of a support material of the present disclosure for printing support structure 32 from the given support material.

Platen 14 is supported by platen gantry 16, which is a gantry assembly configured to move platen 14 along (or substantially along) a vertical z-axis. Correspondingly, print head 18 is supported by head gantry 20, which is a gantry assembly configured to move print head 18 in (or substantially in) a horizontal x-y plane above chamber 12.

In an alternative embodiment, platen 14 may be configured to move in the horizontal x-y plane within chamber 12, and print head 18 may be configured to move along the z-axis. Other similar arrangements may also be used such that one or both of platen 14 and print head 18 are moveable relative to each other. Platen 14 and print head 18 may also be oriented along different axes. For example, platen 14 may be oriented vertically and print head 18 may print printed part 30 and support structure 32 along the x-axis or the y-axis.

System 10 also includes controller 34, which is one or more control circuits configured to monitor and operate the components of system 10. For example, one or more of the control functions performed by controller 34 can be implemented in hardware, software, firmware, and the like, or a combination thereof. Controller 34 may communicate over communication line 36 with chamber 12 (e.g., with a heating unit for chamber 12), print head 18, and various sensors, calibration devices, display devices, and/or user input devices.

System 12 and/or controller 34 may also communicate with computer 38, which is one or more computer-based systems that communicates with system 12 and/or controller 34, and may be separate from system 12, or alternatively may be an internal component of system 12. Computer 38 includes computer-based hardware, such as data storage devices, processors, memory modules, and the like for generating and storing tool path and related printing instructions. Computer 38 may transmit these instructions to system 10 (e.g., to controller 34) to perform printing operations.

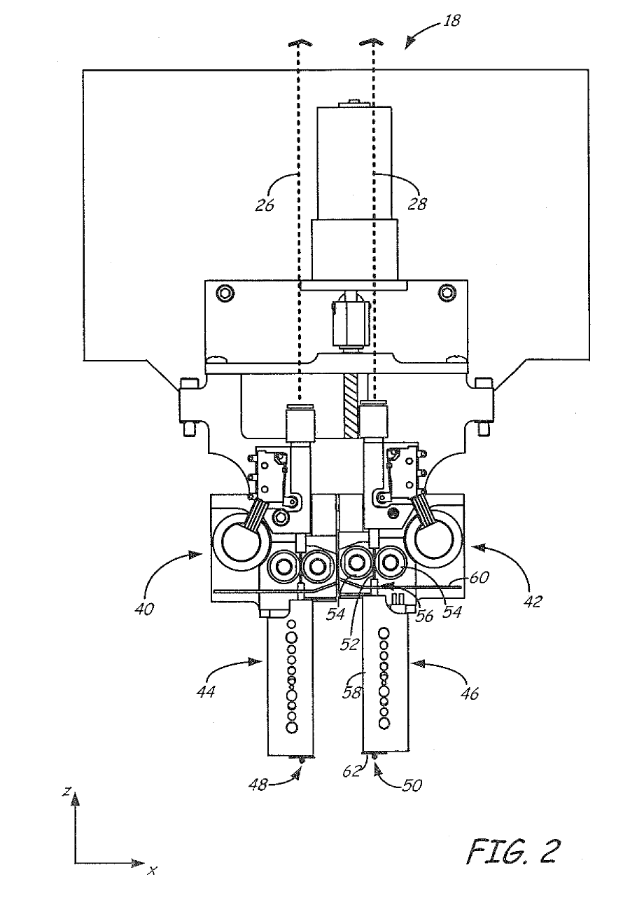

FIG. 2 illustrates a suitable device for print head 18, as described in Leavitt, U.S. Pat. No. 7,625,200. Additional examples of suitable devices for print head 18, and the connections between print head 18 and head gantry 20 include those disclosed in Crump et al., U.S. Pat. No. 5,503,785; Swanson et al., U.S. Pat. No. 6,004,124; LaBossiere, et al., U.S. Pat. Nos. 7,384,255 and 7,604,470; Leavitt, U.S. Pat. No. 7,625,200; Batchelder et al., U.S. Pat. No. 7,896,209; and Comb et al., U.S. Pat. No. 8,153,182. In additional embodiments, in which print head 18 is an interchangeable, single-nozzle print head, examples of suitable devices for each print head 18, and the connections between print head 18 and head gantry 20 include those disclosed in Swanson et al., U.S. Pat. Nos. 8,419,996 and 8,647,102.

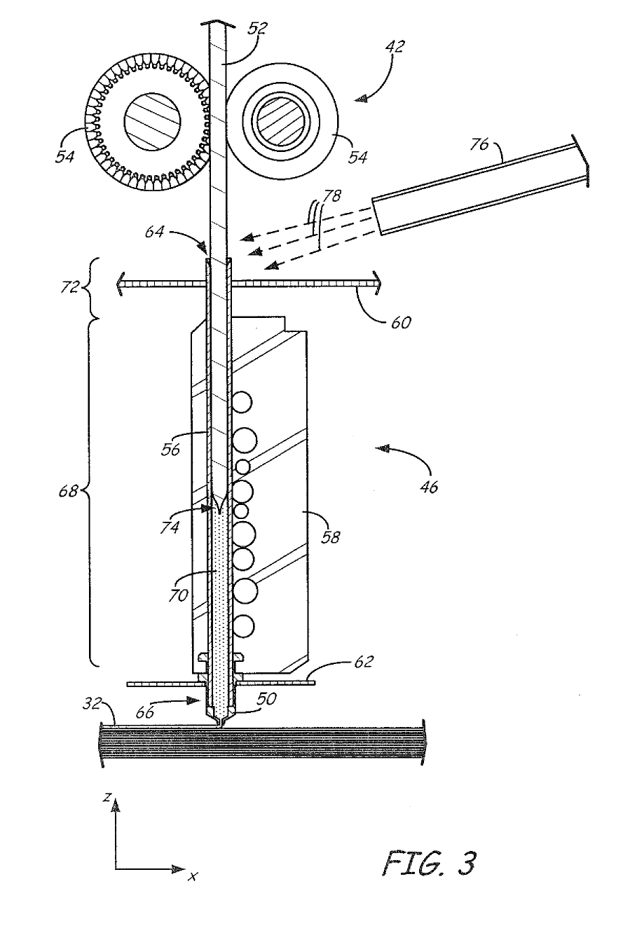

In the shown dual-tip embodiment, print head 18 includes two drive mechanisms 40 and 42, two liquefier assemblies 44 and 46, and two nozzles 48 and 50, where drive mechanism 40, liquefier assembly 44, and nozzle 48 are for receiving and extruding the model material, and drive mechanism 42, liquefier assembly 46, and nozzle 50 are for receiving and extruding the support material of the present disclosure. In this embodiment, the model material and the support material each preferably have a filament geometry for use with print head 18. For example, as shown in FIGS. 2 and 3, the support material may be provided as filament 52.

During operation, controller 34 may direct wheels 54 of drive mechanism 42 to selectively draw successive segments filament 52 (of the support material) from consumable assembly 24 (via guide tube 28), and feed filament 52 to liquefier assembly 46. Liquefier assembly 46 may include liquefier tube 56, thermal block 58, heat shield 60, and tip shield 62, where liquefier tube 56 includes inlet end 64 for receiving the fed filament 52. Nozzle 50 and tip shield 62 are accordingly secured to outlet end 66 of liquefier tube 56, and liquefier tube 56 extends through thermal block 58 and heat shield 60.

While liquefier assembly 46 is in its active state, thermal block 58 heats liquefier tube 56 to define heating zone 68. The heating of liquefier tube 56 at heating zone 68 melts the support material of filament 52 in liquefier tube 56 to form melt 70. Preferred liquefier temperatures for the support material range will vary depending on the particular polymer composition of the support material, and are preferably above the melt processing temperature of the support material.

The upper region of liquefier tube 56 above heating zone 68, referred to as transition zone 72, is preferably not directly heated by thermal block 58. This generates a thermal gradient or profile along the longitudinal length of liquefier tube 56.

The molten portion of the support material (i.e., melt 70) forms meniscus 74 around the unmelted portion of filament 52. During an extrusion of melt 70 through nozzle 50, the downward movement of filament 52 functions as a viscosity pump to extrude the support material of melt 70 out of nozzle 50 as extruded roads to print support structure 32 in a layer-by-layer manner in coordination with the printing of printed part 30. While thermal block 58 heats liquefier tube 56 at heating zone 68, cooling air may also be blown through an optional manifold 76 toward inlet end 64 of liquefier tube 56, as depicted by arrows 78. Heat shield 60 assists in directing the air flow toward inlet end 64. The cooling air reduces the temperature of liquefier tube 56 at inlet end 64, which prevents filament 52 from softening or melting at transition zone 72.

In some embodiments, controller 34 may servo or swap liquefier assemblies 44 and 46 between opposing active and stand-by states. For example, while liquefier assembly 46 is served to its active state for extruding the support material to print a layer of support structure 32, liquefier assembly 44 is switched to a stand-by state to prevent the model material from being extruded while liquefier assembly 46 is being used. After a given layer of the support material is completed, controller 34 then servos liquefier assembly 46 to its stand-by state, and switches liquefier assembly 44 to its active state for extruding the model material to print a layer of printed part 30. This servo process may be repeated for each printed layer until printed part 30 and support structure 32 are completed.

While liquefier assembly 44 is in its active state for printing printed part 30 from a model material filament, drive mechanism 40, liquefier assembly 44, and nozzle 48 (each shown in FIG. 2) may operate in the same manner as drive mechanism 42, liquefier assembly 46, and nozzle 50 for extruding the model material. In particular, drive mechanism 40 may draw successive segments of the model material filament from consumable assembly 22 (via guide tube 26), and feed the model material filament to liquefier assembly 44. Liquefier assembly 44 thermally melts the successive portions of the received model material filament such that it becomes a molten model material. The molten model material may then be extruded and deposited from nozzle 48 as a series of roads onto platen 14 for printing printed part 30 in a layer-by-layer manner in coordination with the printing of support structure 32.

After the print operation is complete, the resulting printed part 30 and support structure 32 may be removed from chamber 12. Support structure 32 may then be sacrificially removed from printed part 30, such as by dissolution in an aqueous solution, aqueous dispersion or tap water. Examples of suitable removal units for dissolving or disintegrating support structure 32 include those disclosed in Swanson et al., U.S. Pat. No. 8,459,280. Using support removal methodology, support structure 32 may at least partially disintegrate in the aqueous solution or dispersion, separating it from printed part 30 in a hands-free manner. Optionally, the soluble material may be used to print a soluble part instead of a support structure. In such a case, the printed part can be used as a soluble mold in a subsequent molding process.

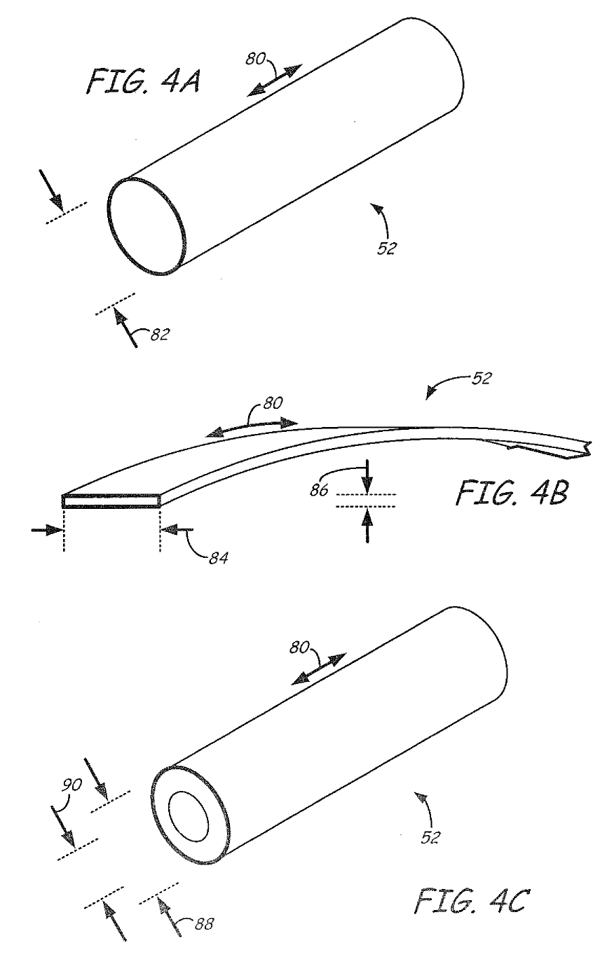

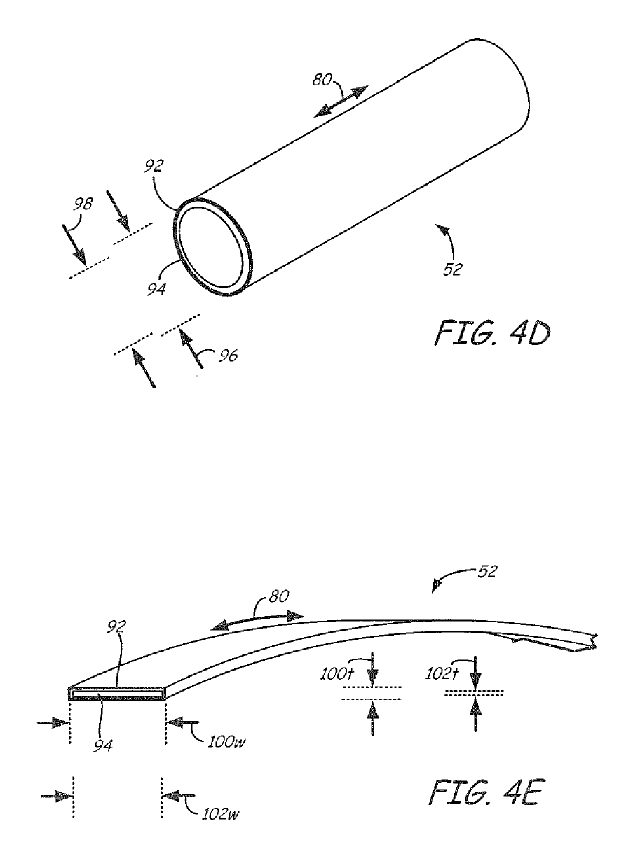

FIGS. 4A-4E illustrate exemplary embodiments for filament 52 produced with the support material and/or part material of the present disclosure. As shown in FIG. 4A, filament 52 may have a cylindrical or substantially cylindrical geometry, such as those disclosed in Crump, U.S. Pat. No. 5,121,329; Crump et al., U.S. Pat. No. 5,503,785; and Comb et al., U.S. Pat. No. 7,122,246. For example, filament 52 may have a longitudinal length 80 and an average diameter (referred to as diameter 82) along longitudinal length 80. As used herein, the term “average diameter” of a filament (e.g., diameter 82) is an average based on a 100-foot segment length of the filament. Diameter 82 may be any suitable dimension that allows filament 52 to be received by a print head of an additive manufacturing system (e.g., print head 18).

Alternatively, as shown in FIG. 4B, filament 52 may have a non-cylindrical geometry, such as a ribbon filament as disclosed in Batchelder et al., U.S. Pat. No. 8,221,669. It is understood that “ribbon filament” may have a rectangular cross-sectional geometry with right-angle corners and/or with rounded corners such as an elliptical or a round geometry. In these embodiments, suitable liquefier assemblies for liquefier assemblies 44 and 46 (shown in FIG. 2) include those disclosed in Batchelder et al., U.S. Application Publication No. 2011/0074065; and in Swanson et al., U.S. Application Publication No. 2012/0070523.

Furthermore, as shown in FIG. 4C, filament 52 may alternatively have a hollow geometry. In this embodiment, filament 52 may have a longitudinal length 80, an average outer diameter (referred to as outer diameter 88) along longitudinal length 80, and an average inner diameter (referred to as inner diameter 90) along longitudinal length 80.

Additionally, as shown in FIGS. 4D and 4E, filament 52 may alternatively have a core-shell geometry, as mentioned above, where the support material may be used to form either the core or the shell. For instance, the support material of this embodiment may function as a soluble shell in combination with a bulk core of a second polymer material, such as a second soluble support material having a lower mechanical strength and modulus, but that has a higher dissolution rate in the aqueous solution. Alternatively, the support material may function as a soluble core in combination with a second soluble support material that exhibits exceptional adhesiveness to an associated model material.

In either the cylindrical embodiment shown in FIG. 4D or the ribbon embodiment shown in FIG. 4E, filament 52 may have a longitudinal length 80, a shell portion 92, and a core portion 94, where the shell portion 92 and core portion 94 each preferably extend along longitudinal length 80. In further alternative embodiments, filament 52 may three or more cross-sectional portions (e.g., a core portion and two or more shell portions).

Alternatively, in the ribbon embodiment shown in FIG. 4E, which is a combination of the embodiments shown above in FIGS. 4B and 4D, shell portion 92 may have an average outer width (referred to as outer width 100w) and an average inner width (referred to as inner width 102w) along longitudinal length 80, where inner width 102w corresponds to an outer width of core portion 94. Similarly, shell portion 92 may have an average outer thickness (referred to as outer thickness 100t) and an average inner thickness (referred to as inner thickness 102t) along longitudinal length 80, where inner thickness 102t corresponds to an outer thickness of core portion 94. Examples of suitable core-shell geometries for this embodiment (e.g., widths 100w and 102w, and thicknesses 100t and 102t) include those discussed in Mikulak et al., U.S. Publication Nos. 2012/0070619 and 2012/0231225, and those discussed above for the ribbon filament 52 in FIG. 4B.

Consumable assembly 24 may include any suitable length of filament 52 as illustrated in FIGS. 4A-4E. Thus, longitudinal length 80 for filament 52 in the embodiments shown in FIGS. 4A-4E is preferably about 100 feet or more. In additional embodiments, filament 52 (e.g., as shown in FIGS. 4A-4E) may include topographical surfaces patterns (e.g., tracks) as disclosed in Batchelder et al., U.S. Pat. No. 8,236,227; and/or may include encoded markings as disclosed in Batchelder et al., U.S. Pat. No. 8,658,250.

Whatever configuration of the filament, the present disclosure provides a barrier on a filament that substantially prevents moisture absorption or gas transmission from the ambient environment while not adversely affecting the performance of the material when melted and extruded into a layer(s) of a part or a support structure. As the barrier is a relatively thin coating to keep the weight % of the barrier below about 1 wt % of the feedstock, the barrier is illustrated with a thick line about the perimeter of each of the embodiments illustrated in FIGS. 4A-4E. The use of the barrier increases the shelf life of the material and the throughput in the printing systems, and may enable the use of certain feedstocks otherwise unusable due to moisture absorption or gas transmission from the ambient environment.

Generally, the present disclosure relates to processes that coats the filament with a coating that prevents the transmission of moisture or gasses from the ambient environment into the filament. The coating can be applied with numerous techniques, where the technique can be dependent upon the material utilized to coat the filament.

The disclosed process includes passing the feedstock through a coating process, followed by a curing process, and finally though a sizing and winding process. In the case of the coating process, the filament can be dip coated, curtain coated, spray coated, coated by vapor deposition, coated by immersion, and coated by coextrusion. The curing process will depend upon the type of material being coated onto the filament. The coating material, when cured forms a moisture barrier and can be any material will be suitable that follows the general requirements of a minimal effective coating required to reduce moisture uptake, minimal impact on filament diameter, rapid coating capability, rapid curing or drying capability, filament compatibility, and printer compatibility.

The coating can be applied to the filament during extrusion and before sizing and winding. Alternatively, the moisture barrier can be applied to existing filament feedstocks without significantly changing the filament diameter allowing feedstocks to be coated after initial filament extrusion and packaging.

For example, polymer or pre-polymer dispersions can be coated onto the filament as a moisture barrier utilizing a dip or spray coating technique. In one embodiment, the filament is extruded and then passed through a coating chamber. The coating is then dried to a solid state such that the moisture impervious barrier is formed. However, the coating is sufficiently thin to allow the same extruder to print the coated filament as the filament without the coating. One exemplary material that forms a moisture barrier after being coated and dried is a low molecular weight polyethylene dispersion. However, other alkene dispersions are also within the scope of the present disclosure. Another group of exemplary materials that can be coated and dried to form the moisture barrier is fluoroacrylates.

In another embodiment, the moisture barrier material is coated and then heated to cure the barrier onto the filament. An exemplary group of materials that are coated and then heated to form the moisture barrier coatings on the filament is dicyandiamine (DICY) cured epoxies.

In another embodiment, the process includes passing the filament through a coating chamber where the filament is coated with material that includes a photo-initiator that causes the coating to cure when exposed to optical energy, such as ultraviolet light. One group of materials that utilize ultraviolet light to cure the coating onto the filament is phosphine oxide photo-initiated acrylic esters.

In another embodiment, the filament is passed through a coating chamber in which a metalized coating is vapor deposited onto the filament. One exemplary material that can be vapor deposited onto the filament is a metal or metal oxide, such as aluminum oxide, which when vapor deposited on the filament, forms a barrier to moisture absorption and gas transmission from the ambient environment into the filament.

In another embodiment, the filament is coextruded utilizing a polymer shell that sufficiently retards moisture uptake or gas transmission into the core polymer.

Whatever material and method of coating the filament, the coating creates a moisture barrier while being less than 1 wt % of the filament weight. The coating also does not interfere with the performance of the material, the compatibility of the material with other materials or the use of the material in the printer or extruder device.

By way of example, additive manufacturing systems can utilize a water soluble support material so that the support material can be removed to expose the printed part utilizing aqueous solutions. However, because water soluble materials readily absorbs moisture from the environment, the use of water soluble feedstock materials has required special packaging and machine conditions. In some cases, a water soluble material will absorb sufficient amounts of water in a short period such that it cannot be printed.

The present disclosure allows for the use of hydrophilic materials in additive manufacturing, as the barrier prevents absorption of moisture without requiring the use of rigorous packaging. The present disclosure allows the use of material in extrusion-based additive manufacturing system, such as fused deposition modeling 3D printers, that previously could not be used due to the absorption of moisture.

However, when using a hydrophilic material as a support material, the support material is typically removed from the part material in an aqueous bath. Therefore, if the barrier remains intact when extruded, the barrier could impede or prevent the removal of the support material from the part. It has been discovered that as the material is extruded the barrier is significantly disrupted, which allows the support material to be removed through immersion in the aqueous bath. It is believed that the barrier is disrupted due to the thinness and rigidity of the coating and the elongation of the filament as it is extruded through a print head nozzle, even where flow exists within the liquefier.

As mentioned above, the barrier with the same chemistries utilized to prevent moisture absorption also prevent the transmission of gasses, such as oxygen, from the ambient environment into the filament. Otherwise stated, the barrier maintains the composition and materials in substantially the same state as when the materials were manufactured in a filament form.

An additional benefit of the filament coated with the moisture barrier is that the packaging does not need to be sealed to the environment. Because the packaging does not need to be sealed, less expensive packaging can be used which reduces costs and increases processing efficiencies. For instance, the filament with the barrier could be wound onto a spool without placing the spool within a container.

Additionally, some printers utilize drying equipment to prevent moisture uptake within the system. This drying equipment can be expensive to purchase, install and operate. The present disclosure does not require the typical drying systems with the printer 10.

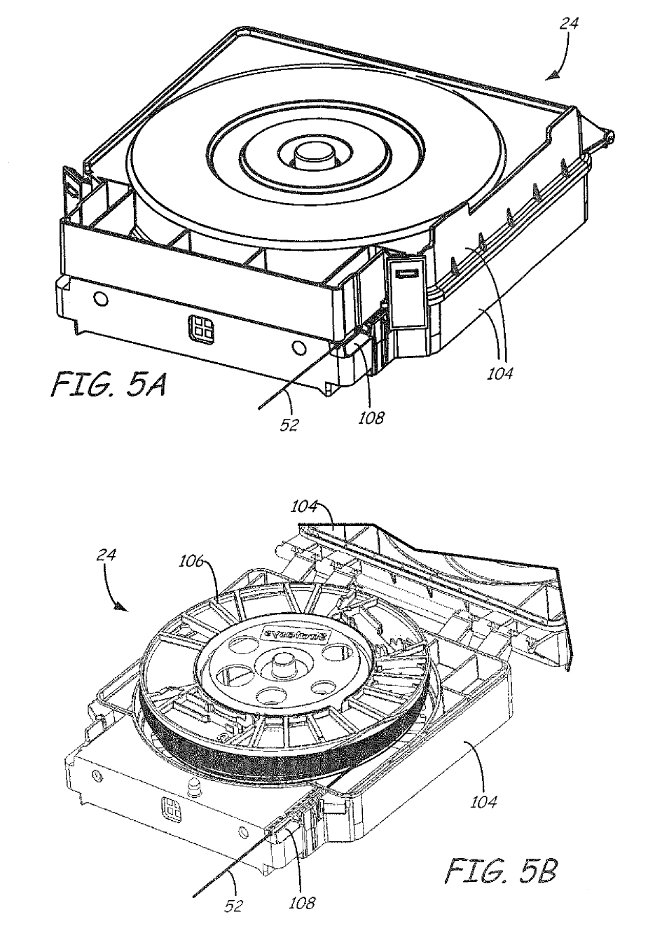

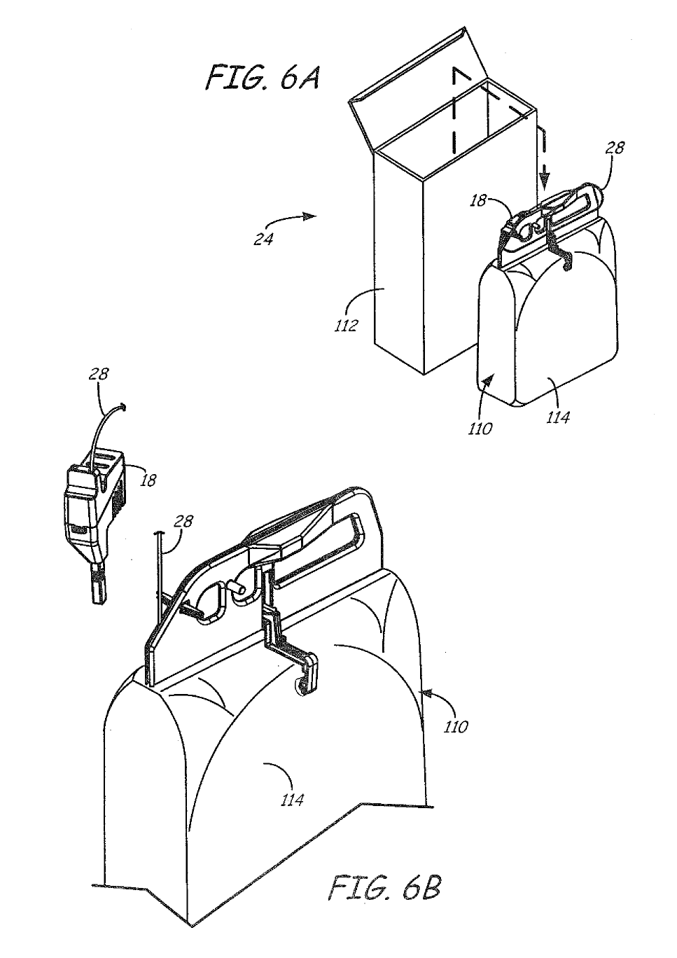

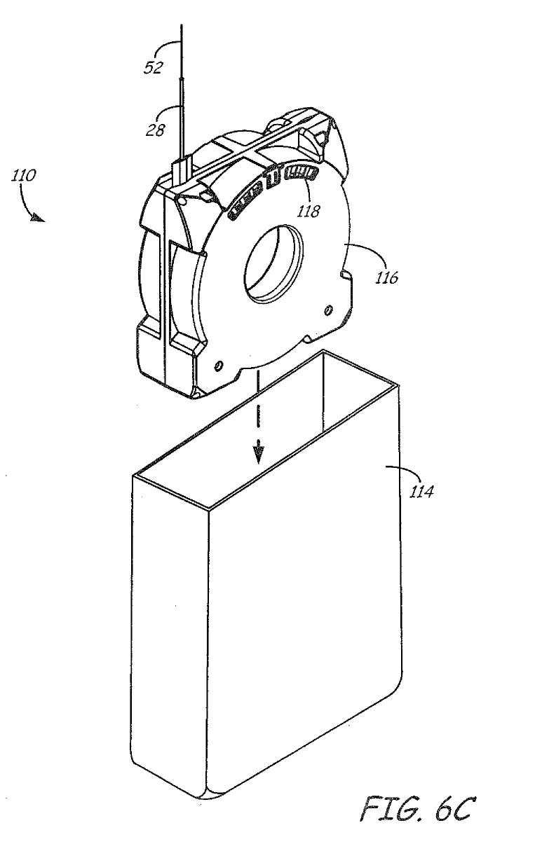

In other FDM systems the material is dried to a sufficient moisture level. The filament is then packaged into sealed packages that prevent moisture penetration. By way of example of the rigorous packaging required to prevent moisture uptake with the materials, FIGS. 5A-6C illustrate examples of suitable consumable assemblies for consumable assembly 24, which may retain a supply of filament 52 of the support material. For example, FIGS. 5A and 5B illustrates consumable assembly 24 with a container portion 104, spool 106, and guide mechanism 108, where container portion 104 is configured to open and close in a sealing manner as shown to retain spool 106 and guide mechanism 108. Spool 106 accordingly retains a supply of filament 52 of the support material, and relays filament 52 out of consumable assembly 24 via guide mechanism 108.

FIGS. 6A-6C illustrate an alternative embodiment for print head 18, consumable assembly 24, and guide tube 28, which are combined into a single, removable assembly, such as disclosed in Mannella et al., U.S. Publication Nos. 2013/0161439 and 2013/0161442. As shown in FIG. 6A, in this embodiment, consumable assembly 24 preferably includes container portion 110, which may be retained in a storage box 112, and is configured to mount print head 18 and guide tube 28.

As shown in FIG. 6B, print head 18 and guide tube 28 may be unmounted from container portion 110 and loaded to system 10 such that print head 18 is moveably retained by gantry 20, such as disclosed in Swanson, U.S. Publication Nos. 2010/0283172 and 2012/0164256. As shown in FIG. 6C, container portion 110 may include liner 114, rigid module 116, and spool 118, where spool 118 is rotatably mounted within rigid module 116 and retains a supply of filament 52 of the support material. Rigid module 116 may also be secured within liner 114, which is preferably a moisture and/or gas-barrier liner.

In each of the above-discussed embodiments for consumable assembly 24 (e.g., as shown in FIGS. 5A-6C), the retained supply of filament 52 of the support material is preferably maintained in a dry state, as mentioned above. As such, consumable assembly 24 may be pre-dried and sealed to prevent moisture absorption. Additionally, consumable assembly 24 may include one or more desiccant packs to maintain a dry environment during transportation, storage, and use. In alternative embodiments, the support material may be unsealed and exposed to atmospheric conditions during storage, transportation, and use with system 10.

In each of the above-discussed embodiments for consumable assembly 24 (e.g., as shown in FIGS. 5A-6C), the retained supply of filament 52 of the support material is preferably maintained in a dry state, as mentioned above. As previously discussed, consumable assembly 24 may be pre-dried and sealed to prevent moisture absorption. Additionally, consumable assembly 24 may include one or more desiccant packs to maintain a dry environment during transportation, storage, and use. In alternative embodiments, the support material may be unsealed and exposed to atmospheric conditions during storage, transportation, and use with system 10.

As discussed above, current practice is to dry the material prior to packing the material and then utilizing rigorous packaging and processing practices to maintain the material in a dry state until it is printed. This type of packaging and processing requirement adds significant costs and processing complexities.

The present disclosure eliminates the need for rigorous packing techniques and preserves the life of the feedstock by coating the filament feedstock with a barrier that is substantially impervious to moisture absorption and/or the transmission of gasses into the filament. The present disclosure also reduces the need for significant drying equipment in the printer system because moisture is substantially prevented from being absorbed by the feedstock. Further, the present disclosure allows printing of that would not otherwise be able to be used because of the rapid absorption of moisture.

### EXAMPLES

The present disclosure is more particularly described in the following examples that are intended as illustrations only, since numerous modifications and variations within the scope of the present disclosure will be apparent to those skilled in the art.

### Example 1

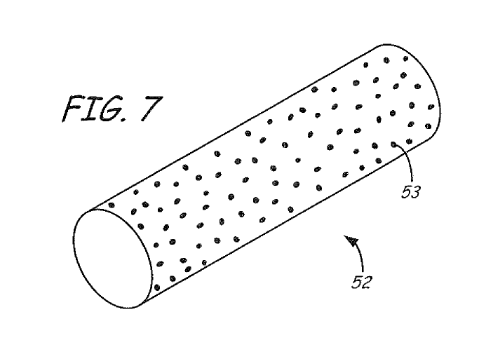

Filament having a composition of 100% by weight water soluble polyvinyl alcohol, was placed into a nano evaporation system and coated with approximately 700 angstroms of aluminum, under vacuum. The resulting filament included a smooth, continuous moisture barrier about the outer surface, such as the filament illustrated in FIG. 4A. The coated filament was then extruded through an FDM liquefier, (Replicator 2, Makerbot Industries, Brooklyn N.Y.) at 230° C. The subsequent extrudate was imaged, which disclosed significant disruption of the coating such as illustrated at 53 on the filament 52 in FIG. 7 where the coating was disrupted to discontiguous areas on the extrudate.

The extrudate was then submerged in substantially neutral water having a pH of about 6.6 until the polymer was dissolved. In the analyzed sample, the barrier material could not be discerned from the solution. Further, the disrupted barrier did not substantially increase the time required to dissolve the support material relative to an extrudate of the same material without the barrier.

Although the present disclosure has been described with reference to preferred embodiments, workers skilled in the art will recognize that changes may be made in form and detail without departing from the spirit and scope of the disclosure.

1. A material for an additive manufacturing system having a build environment, the material comprising:
a filament coated with a barrier wherein the barrier comprises less than about 1 wt % of the filament and substantially prevent moisture or gasses from transmitting into the filament.

2. The material of claim 1 and wherein the filament comprises a thermoplastic material.

3. The material of claim 1 and wherein the thermoplastic material that is capable of absorbing moisture or oxygen.

4. The material of claim 1 and wherein the barrier comprises a metal or a metal oxide.

5. The material of claim 4 and wherein the metal comprises aluminum or aluminum oxide.

6. The material of claim 1 and wherein the barrier comprises polymers or copolymers of an alkene or a fluoroacrylate.

7. The material of claim 1 and wherein the barrier comprises an epoxy.

8. The material of claim 8 and wherein the epoxy comprises dicyandiamine cured epoxy.

9. The material of claim 1 and wherein the barrier comprises silane and/or polydimethylsiloxane.

10. The material of claim 1 and wherein the barrier comprises phosphine oxide photoinitiated acrylic esters.

11. A method of producing a thermoplastic filament with a barrier wherein the filament is configured for use in an additive manufacturing system, the method comprising:
providing a filament comprising water-soluble material or an oxygen absorbing material;
passing the filament though a coating process such that an exterior surface is coated with a material that resists moisture and the absorption of gasses;
fixing the coated material to the filament such that the material substantially covers the exterior of the filament and comprises less than about 1 wt % of the filament and prevents the transmission of moisture and/or gasses into the filament.

12. The method of claim 11 and wherein the coating process comprises dip coating, curtain coating, spray coating, vapor deposition coating or coating by immersion.

13. The method of claim 11 and wherein the fixing process comprises drying, thermal curing and optical energy curing.

14. The method of claim 11 and wherein the material used to coat the filament comprises a metal or a metal oxide.

15. The method of claim 14 and wherein the metal comprises aluminum.

16. The method of claim 11 and wherein the material used to coat the filament comprises an alkene or a fluoroacrylate.

17. The method of claim 11 and material used to coat the filament comprises an epoxy.

18. The method of claim 17 and wherein the epoxy comprises dicyandiamine cured epoxy.

19. The method of claim 11 and material used to coat the filament comprises silane and/or polydimethylsiloxane dispersions.

20. The method of claim 11 and material used to coat the filament comprises phosphine oxide photo-initiated acrylic esters.

21. A method of print a three-dimensional part in a layer by layer manner where each layer includes a plurality of roads, the method comprising:
providing a thermoplastic material in a filament that is coated with a barrier wherein the barrier comprises less than about 1 wt % of the filament and substantially prevent moisture or gasses from transmitting into the filament to an additive manufacturing system;
melting the filament in the additive manufacturing system; and
extruding at least a portion of the three-dimensional part or a support structure from the melted thermoplastic material wherein extrusion causes an elongation force resulting the barrier becoming discontinuous such that the extruded material in adjacent roads and layers bond together and the barrier does not adversely affect the bonding of the adjacent thermoplastic material.

22. The method of claim 21 and wherein the thermoplastic material comprises a moisture sensitive material or absorbs oxygen.

23. The method of claim 21 and wherein the barrier comprises a metal or a metal oxide.

24. The method of claim 23 and wherein the metal comprises aluminum or aluminum oxide.

25. The method of claim 21 and wherein the barrier comprises polymers or copolymers.

26. The method of claim 21 and wherein the barrier comprises an alkene or a fluoroacrylate.

27. The method of claim 21 and wherein the barrier comprises an epoxy.

28. The method of claim 27 and wherein the epoxy comprises dicyandiamine cured epoxy.

29. The method of claim 21 and wherein the barrier comprises silane and/or polydimethylsiloxane.

30. The method of claim 21 and wherein the barrier comprises phosphine oxide photoinitiated acrylic esters.
